(19) United States
(12) Patent Application Publication
(10) Pub. No.: US 2006/0086145 A1
(43) Pub. Date: Apr. 27, 2006

(54) Process for hot shaping flat borosilicate glass, hollow glass body made by this process and the use of same as a measuring body sleeve in a neutrino detector

(76) Inventors: Wolfgang Berninger, Waldaschaff (DE); Thomas Kloss, Jena-Gospeda (DE); Heinz-Dieter Trost, Milda (DE); Horst Schillert, Gruenenplan (DE)

Correspondence Address: STRIKER, STRIKER & STENBY, 103 EAST NECK ROAD, HUNTINGTON, NY, 11743, US

(21) Appl. No.: 11/254,410

(22) Filed: Oct. 20, 2005

(30) Foreign Application Priority Data
Oct. 21, 2004 (DE) 10 2004 051 329.5

(51) Int. Cl. C03B 23/035

(52) U.S. Cl. 65/106; 65/67

(57) ABSTRACT

In order to avoid distortions or wall thickness variations in a glass wall, especially of a hollow glass body, formed by hot shaping, the hot shaping is performed by a vacuum forming or vacuum-deep drawing process. A hollow glass body and a measuring body sleeve for a neutrino detector made by this method are also described. The measuring body sleeve does not have distortions or wall thickness variations that can interfere with measurements.

### BACKGROUND OF THE INVENTION

1. Field of the Invention

The present invention relates to a process for hot shaping flat glass, especially float glass, comprising borosilicate glass. The invention also relates to a hollow glass body made with this process and to its use as a measuring body sleeve in a neutrino detector.

2. Related Art

Borosilicate glass is a boric acid-containing silicate glass, which typically has 70 to 80% SiO₂, 7 to 13% boric oxide (B₂O₃), 4-8% Na₂O and K₂O as well as 2 to 7% aluminum oxide (Al₂O₃). Glass with this sort of composition typically has a high resistance to chemical action and temperature differences. Thus it is primarily used in the chemical industry for laboratory and pharmaceutical apparatus, but also in the home as “heat-resistant cookware or kitchenware”.

Flat glass comprising borosilicate glass can be made by vertical and horizontal drawing processes. However the float process for forming flat glass is of special importance. A floated borosilicate glass can be made with very smooth surfaces and uniform thickness of optical quality. For example, the borosilicate glass known under the trademark BOROFLOAT® is a known high quality borosilicate float glass.

Besides good UV transmission the borosilicate glass has very small linear thermal expansion, which can differ according to the glass composition. It is usual to assign a characteristic number referring to the respective value of the thermal expansion coefficient to the glass name. For example, the linear thermal expansion coefficient of the typical borosilicate glass 3.3 or BOROFLOAT® 33 IS 3.3×10⁻⁶/K.

Drawn borosilicate flat glass or borosilicate float glass is a typical semi-finished product that is used for further processing to make different glass products. Hot shaping of flat glass pieces is frequently required during this further processing.

Currently the classical bending or blowing method is used to shape flat glass pieces, e.g. borosilicate glass plates, especially comprising BOROFLOAT® glass. In the classical bending method the shaping takes place by action of gravity with the assistance of silicate or suitable metal molds. Distortions or wall thickness variations in the shaped glass wall arise in this known bending or blowing process, which can interfere with the applications of the shaped glass body, e.g. as a measuring body sleeve. However refinements or corrective measures can still occur during subsequent cold working, such as grinding and polishing, however the work increases greatly and with it the costs.

### SUMMARY OF THE INVENTION

It is an object of the present invention to provide a process for hot shaping borosilicate flat glass, which does not have the above-described disadvantages.

It is another object of the present invention to provide a hollow glass body or semi-finished product, especially a measuring body sleeve, without distortions, or wall thickness variations.

According to the invention the hot shaping of borosilicate flat glass occurs by means of a vacuum-deep drawing process.

The vacuum-deep drawing process advantageously enables the flat glass to be shaped already in a viscous state to fit the shape of the vacuum mold, without the softened glass mass changing its uniform thickness spectrum. Thus distortions in the wall or wall thickness variations are avoided. Then this process facilitates very uniform shaping of borosilicate glass, especially to form a hollow glass body, which cannot be achieved by the above-described conventional bending technique or by the conventional blowing technique by means of a glass maker or glass making apparatus.

The shaped article, i.e. especially the hollow glass body, obtained by this vacuum shaping process retains its optical quality, equal to that of the starting material.

Preferably the vacuum-deep drawing process according to the invention includes the following steps:

a) preparing a borosilicate glass plate that is cut to a final format or size of the article to be formed;

b) placing the borosilicate glass plate cut to the final format in a pre-heated vacuum mold;

c) heating the borosilicate glass plate to a viscous state;

d) applying a vacuum to the pre-heated vacuum mold under the borosilicate glass plate in order to adapt or conform the borosilicate glass plate heated to its viscous state to the shape of the pre-heated vacuum mold; and

e) cooling a glass article, especially a hollow glass body, formed from the borosilicate glass plate.

This process facilitates economical manufacture of shaped glass bodies, specially the hollow glass body, from borosilicate flat glass.

Chromium nickel steel with a carbon content of 0.2 to 0.25% is used as mold material for the vacuum mold. This mold material is characterized by high mold stability, even at shaping temperatures greater than 800° C., and the glass is not inclined to stick to the mold. The mold geometry is designed so that a uniform lowering or drawing down of the glass occurs during the vacuum drawing process, without damaging the surface. If the surface of the mold were highly polished by an expensive working step, then only the smallest faults would be formed on the glass surface.

The round plate (plate) worked to size is placed in a pre-heated steel mold and they are transported together into an oven. This guarantees that the draw down process occurs uniformly, so that a uniform glass thickness is maintained over the entire surface.

The glass temperature is continuously monitored with the aid of a temperature sensor (Pyrometer).

The low pressure (vacuum) of 0.1 to 0.6 bar employed in the vacuum-deep drawing is suitably controlled by means of a valve.

When the shaping deformation process is finished the shaped glass article must remain for certain time period in the mold, before it can be removed with a vacuum or suction from the mold.

Embodiments of the process according to the invention, in which borosilicate float glass is employed as the borosilicate glass and especially in which commercially available BOROFLOAT® GLASS is used, are preferred.

These embodiments of the process according to the invention especially produce hollow glass bodies made from borosilicate glass with very smooth outer and inner surfaces. These very smooth surfaces are best suited as substrate surfaces for mirrors and coatings in the nm and μm range.

When a borosilicate glass with a linear thermal expansion coefficient of 3.3×10⁻⁶/K is used in further embodiments of the process according to the invention, then additional application possibilities for the shaped glass article arise, especially for hollow borosilicate glass bodies, particularly in regard to heat resistance and/or temperature stability.

Borosilicate glass can be used in new demanding applications when the borosilicate glass is processed according to the present invention. Primarily it is possible to connect larger hollow glass bodies formed according to the invention by means of further parts, such as tubes and transitional glass, with any metal in a vacuum-tight and pressure-resistant manner, so that excellent glass blowing and processing is possible.

Sleeves for neutrino detectors can be made for example with special advantages. A material, which has a good UV transmission, is required for these measurement bodies. At the same time the sleeves must be a body, which can withstand pressures up to 8 bar and thus must have a uniform wall thickness over its entire body.

Primarily the connections to the electronic measuring units must be hermetically encapsulated in the sleeve, which avoids pressure loss and out-gassing.

These requirements may be fulfilled by a hollow borosilicate glass body made according to the engineering method according to the invention, since the measuring body sleeve is in a position to guarantee the required radiation transmission in the actual radiation spectrum without interfering factors, which would produce faulty measurement results.

The disclosure in German Patent Application 10 2004 051 329.5-45 of Oct. 21, 2004 is incorporated here by reference. This German Patent Application describes the invention described hereinabove and claimed in the claims appended hereinbelow and provides the basis for a claim of priority for the instant invention under 35 U.S.C. 119.

While the invention has been illustrated and described as embodied in a process for hot shaping flat borosilicate glass, a hollow glass body made by this process and the use of same as a measuring body sleeve in a neutrino detector, it is not intended to be limited to the details shown, since various modifications and changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention. What is claimed is new and is set forth in the following appended claims.

We claim:

1. A process for hot shaping borosilicate flat glass, wherein said hot shaping takes place by a vacuum-deep drawing process.

2. The process as defined in claim 1, wherein the borosilicate flat glass is borosilicate float glass.

3. The process as defined in claim 2, wherein the borosilicate float glass has a linear thermal expansion coefficient of 3.3×10⁻⁶/K.

4. The process as defined in claim 1, comprising the steps of:
a) preparing a borosilicate glass plate that is cut to a final format of the article to be formed;
b) placing the borosilicate glass plate in the final format in a pre-heated vacuum mold;
c) heating the borosilicate glass plate to a viscous state;
d) applying a vacuum to the pre-heated vacuum mold under the borosilicate glass plate in order to adapt the borosilicate glass plate heated to said viscous state to the shape of the pre-heated vacuum mold; and
e) after the applying of step d), cooling a glass body formed from the borosilicate glass plate.

5. The process as defined in claim 4, wherein the borosilicate flat glass is borosilicate float glass.

6. The process as defined in claim 5, wherein the borosilicate float glass has a linear thermal expansion coefficient of 3.3×10⁻⁶/K.

7. The process as defined in claim 5, wherein the borosilicate float glass is BOROFLOAT® glass.

8. A hollow glass body made by a process for hot shaping borosilicate flat glass, wherein said hot shaping takes place by a vacuum-deep drawing process, whereby said hollow glass body has no distortions or wall thickness variations.

9. A measuring body sleeve for a neutrino detector, said measuring body sleeve consisting of the hollow glass body as defined in claim 8.

10. A hollow glass body made by a process for hot shaping borosilicate flat glass, wherein said hot shaping takes place by a vacuum-deep drawing process, whereby said hollow glass body has no distortions or wall thickness variations, wherein said process comprises the steps of:
a) preparing a borosilicate glass plate that is cut to a final format of the article to be formed;
b) placing the borosilicate glass plate in the final format in a pre-heated vacuum mold;
c) heating the borosilicate glass plate to a viscous state;
d) applying a vacuum to the pre-heated vacuum mold under the borosilicate glass plate in order to adapt the borosilicate glass plate heated to said viscous state to the shape of the pre-heated vacuum mold; and
e) after the applying of step d), cooling the hollow glass body formed from the borosilicate glass plate.

11. The hollow glass body as defined in claim 10, wherein said borosilicate glass plate comprises a borosilicate float glass with a linear thermal expansion coefficient of 3.3×10⁻⁶/K.

12. A measuring body sleeve for a neutrino detector, said measuring body sleeve consisting of the hollow glass body as defined in claim 9.
